(19) United States
(12) Patent Application Publication
(10) Pub. No.: US 2025/0069587 A1
(43) Pub. Date: Feb. 27, 2025

(54) System for users to create and use bots

(71) Applicants: Bruce H Haley, Seattle, WA (US); Jeffrey T Haley, Mercer Island, WA (US)

(72) Inventors: Bruce H Haley, Seattle, WA (US); Jeffrey T Haley, Mercer Island, WA (US)

(21) Appl. No.: 18/237,403

(22) Filed: Aug. 24, 2023

(51) Int. Cl. G10L 13/08; G06F 40/40; G06N 5/02; G10L 15/26

(52) U.S. Cl. CPC G10L 13/08; G06F 40/40; G06N 5/02; G10L 15/26

(57) ABSTRACT

A method for creating and using named bots (computer-only robots) with a computer or a smart mobile telephone. The method also allows users of broad computerized systems of knowledge or skills to provide metadata or a scenario input by natural language voice along with a prompt to improve the response.

A method for creating and using named bots (computer-only robots) with a computer or a smart mobile telephone. The method also allows users of broad computerized systems of knowledge or skills to provide metadata or a scenario input by natural language voice along with a prompt to improve the response.

### BACKGROUND

A computerized system of knowledge or skills allows for input of commands or queries or requests or prompts (hereinafter “prompts”) which cause the system to respond with actions or responses (hereinafter “responses”). Such systems that can provide responses to queries are often called “bots”. Examples of bots include Alexa, Siri, Google Assistant, Chat GPT, the chat function on innumerable websites, particularly sites for selling. Bots can be used to create art or music or computer programs. The system of knowledge or skills may or may not have been generated with machine learning. Historically, most systems of knowledge or skills have a limited set of possible prompts.

System builders have recently been building systems of knowledge or skills that are so broad that the numbers of possible prompts that will work is so high that a way of narrowing the range of knowledge or skills is needed to obtain more useful or higher quality output. The way of narrowing the range may be called input of “metadata” or a “scenario” along with input of the prompt.

For example, in the GPT (generative pre-trained transformer) systems of knowledge or skills from Open AI, which systems are called “models,” the Open AI company has provided to programmers who want to build applications that use the models (hereinafter “systems”), via an Applications Programming Interface (API), the ability to specify along with a prompt a set of metadata (or a “scenario”) that will narrow the range of knowledge or skills that the system will call upon to determine the response.

In the API for the Open AI models (or “systems”), data that is input as a prompt is designated by the programmer with a header called “user” while the accompanying metadata or scenario is designated by the programmer with a header called “system”. Using text from programming commands that adhere to a strict programming format as specified by the API, a programmer can build an application that will allow a user who has no programming skills to provide without a strict format input in the form of a prompt and the application built by the programmer will supply to the API an appropriate “system” command (which is metadata or a scenario) in the proper format as predetermined by the programmer who built the application.

Thus, a programmer who builds an application to work with a computerized system of knowledge or skills, such as a bot, can include a voice to text conversion program to convert a user's natural language voice input to text and that text can be a prompt that is input to the system along with metadata selected by the programmer which metadata is used by the system to narrow the range of possible responses to the prompt. Allowing a user to interact with the programmer's application by voice input allows the system to be used by a user with no programming expertise, and the programmer's selection of metadata to be input along with the prompt allows the programmer to improve the quality of result according to the programmer's wishes. However, the range of possibilities is still constrained by the programmer's conception of what should be the metadata or scenario.

### SUMMARY OF THE INVENTION

In one aspect, the invention is a software application or method that allows the user of a broad computerized system of knowledge or skills to provide to the system a set of metadata by him or herself without the services of a programmer and without needing any knowledge or skill in programming or the formatting requirements of the system. Such metadata is conceived of by the user. The metadata is used by the system to improve the quality of its responses when interacting with the user. In one embodiment, the metadata is referred to by the application and by the user as a “scenario” and the scenario information is input by the user simply using the user's natural language voice. The software application converts the voice to natural language text and provides whatever formatting and headers are required by the system.

In the language of the Open AI systems (which Open AI calls “models”) the invented software application or method adds to the scenario (metadata) that is input a header called “system” and puts the scenario text in a proper format for input to the model.

A scenario is a set of instructions that guide or constrain the bot in its behavior. The format and content of the scenario is dependent on the requirements of the knowledge base with which it is used. With some knowledge bases, the length of the scenario instruction set can be thousands of words. In one embodiment, the scenario is input by voice from the user as a string of natural language words. In another embodiment, the scenario instruction set can be entered by selecting from a list of options.

In the embodiments of this invention, a scenario persists in the working life of the created bot. In preferred embodiments, once the scenario is set, it is never changed. Rather, if a different scenario is desired, a new bot is created. However, in some embodiments, the user may have the power to change the scenario. For example, if the scenario is created by selecting from a list of options, the user can change the options selected.

In another aspect, the invention is a method for creating and using named bots using a system comprising a server computer coupled to a communications link and a user computer coupled to the communications link. The server computer has a database of knowledge or skills and responds with output based on the knowledge or skills when a prompt input is provided by a user. The server receives from a user at a user computer a specification in free form natural human language of a scenario, which scenario constrains the range of possible responses output by the database when prompted by a user. The scenario specification provided by the user is saved in a memory, and a bot name provided by the user is saved in association with the scenario specification. When the server receives from the user computer input of a prompt associated with the bot name, the server responds with output that is constrained by the scenario specified by the bot name.

In a preferred embodiment, the user computer is a mobile telephone and the specification in natural human language is provided by a user speaking into a microphone coupled to the user computer. In an alternate embodiment, the functions of the server computer and the functions of the user computer coexist on a single device or on a device array.

A part or all of the database of knowledge or skills may be knowledge or skills provided by the user. The database of knowledge or skills may be a large language model artificial intelligence system.

### DRAWING

FIG. 1 shows a user 1 who uses a smart phone 2 to create a bot that makes use of skills or knowledge on a server 3.

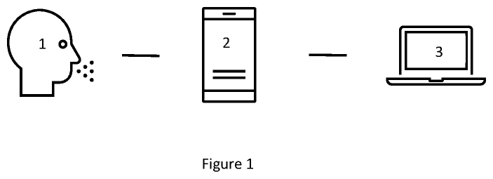

### DETAILED DESCRIPTION

A preferred embodiment of the bot system comprises two parts: the client app and the bot service. The client app preferrably runs on a mobile smart phone 2 such as an Android or iOS phone. The bot service runs on a server 3 such as the Microsoft Azure cloud platform. The user 1 inputs voice or text using the client app running on the phone 2. The client app interacts with the bot service using Microsoft's Azure AI Speech which converts voice to text and text to voice. The bot service receives and acts on user utterances received in the form of text.

User utterances are of two types: 1) for setting up and training a new bot (setup utterances), and 2) for interacting with a bot. Some setup utterance examples include: “Create a new bot named Lynne” or “Change your voice to an Australian accent” or “Change your bot type to List”. Setup utterances also define bot conversational behaviors. Examples of such setup utterances include: “When I say ‘Jump’, then you say ‘How high’”, or things to remember, as in the case of a shopping list bot: “Corn flakes” and “Milk”.

### Bot Service

The bot service may be patterned on Microsoft Azure AI Services Speech Service's Echo Bot sample written in C#, documented here: Tutorial: Voice-enable your bot https://learn.microsoft.com/en-us/azure/ai-services/speech-service/tutorial-voice-enable-your-bot-speech-sdk

To the Echo Bot sample a Dictionary class may be added containing all the setup utterances a user would employ in order to create and train a bot. Also added is code that looks up in the Dictionary a match to each user utterance, then executes a piece of code that carries out the bot setup action specified by the utterance.

Also added to the Echo Bot sample is code that saves a bot's characteristics, conversation state, and conversational responses to a JSON file, the “bot database”. The bot database defines a bot's behavior. When a user interacts with a bot, the bot service gets that information from that bot's database in order to compose the bot's response and send it to the client app. The bot service can create and maintain any number of bot databases for a given user according to that user's requests. The bot databases are preferably downloaded to the client device but they may be stored elsewhere.

### Client App

The client app may be built in C# using Microsoft's Xamarin platform (now known as “.NET Maui”) targeting Android and iOS devices. The C# code for interacting with the bot service via Microsoft's Azure Speech Service may be patterned from Microsoft's Windows Voice Assistant Client, found here: https://github.com/Azure-Samples/Cognitive-Services-Voice-Assistant/blob/main/clients/csharp-wpf/README.md

The primary job of the client app is to upload user utterances to the bot service and to present the service's responses to the user in audio format and/or in a text listing of the user's utterances and the bot service's responses.

### Bot Database Storage

The preferred embodiment does not task the bot service with storing all users' bot databases. Instead, each client app instance stores its user's bot databases on the user's phone or computer.

When a user starts interacting with a given bot, the client app uploads that bot's database to the service. As long as the user remains active with that bot, the service maintains and updates that bot database and sends updates to the client app. The client app then maintains a mirrored copy of the database on the user's phone. When the user ceases interaction, the service may delete its copy. (This is typical caching behavior.)

The code for mirroring may be patterned after Daniel Parker's JSON Patch and JSON Merge Patch, code samples found here: https://github.com/danielaparker/JsonCons.Net#readme

### Background Communication.

The client app and the bot service message each other in the background in order to exchange state data and bot database data. This communication uses the existing speech to text service channels. The text for each data exchange is prefixed by a character sequence tagging it as an internal background message. The code at the receiving end then recognizes it as a data communication and not a user message, and routes the data appropriately.

### Large Language Model Interaction

The bot service supports bots having the Chat GPT large language model as a back end. In this case, the user defines a bot's personality characteristics. They are stored in the bot database as a “scenario”. Example: “You are a professor at Oxford University. You use big words, the more syllables the better. You make jokes and puns.” When the user interacts with the bot, the bot service sends the scenario information to Chat GPT along with the user's utterance. That tells Chat GPT how to word its response. Upon receiving Chat GPT's response, the bot service forwards it through the normal speech service channel to the client app.

The C# code for the ChatGPT interface may be written using Ricardo Mauro's sample found here: Getting Started with Chat GPT integration in a .NET C# Console Application https://rmauro.dev/getting-started-with-chat-gpt-integration-with-csharp-console-application/

The above description and examples do not limit the scope of the invention. The invention is specified by the following claims.

1. A method for a user to create, use, and maintain control of named bots, comprising:
a. having a system comprising a server computer with a database of knowledge or skills which database responds with output based on the knowledge or skills when prompt input is provided by a user, the server coupled to a user computer via a communications link;
b. receiving on the user computer from a user a specification in free form natural human language of a personally created bot scenario specification consisting predominantly of natural human language instructions for guiding or constraining a bot in its desired behavior;
c. saving in a memory on the user computer the bot scenario specification and saving in association with the bot scenario specification a bot name provided by the user;
d. on the user computer, receiving from a user input of the bot name and, in response, sending to the server the bot scenario specification stored in the user computer which bot scenario specification is specified by the bot name;
e. receiving at the user computer input of a prompt which the user computer then sends to the server which responds with output of knowledge or skills that is guided and constrained in content or style or both by the bot scenario specification specified by the bot name.

2. The method of claim 1 where the user computer is a mobile telephone.

3. The method of claim 1 where the specification in natural human language is provided by a user speaking into a microphone coupled to the user computer.

4. The method of claim 1 where a part or all of the database of knowledge or skills is knowledge or skills provided by the user.

5. The method of claim 1 where the database of knowledge or skills is a large language model artificial intelligence system.

6. The method of claim 1 where the functions of the server computer and the functions of the user computer coexist on a single device or device array.

7. The method of claim 1 where the communications link is a computer network using Internet Protocol.

8. A method implemented with computer systems, comprising:
(a) having a computerized system of knowledge or skills that accepts as input one or more prompts in a first defined format and accepts as additional input metadata in a second defined format to accompany the prompts and, in response to input of one or more prompts in the first defined format plus metadata in the second defined format, outputs a response; and
(b) having an application program that accepts free form natural language voice input and, in response to such input, converts voice input to text and organizes the text into one or more prompts in the first defined format plus one or more strings of metadata in the second defined format to accompany the one or more prompts;
(c) wherein a user provides natural language voice input to the application program and, in response, the application program converts the voice input to text and surrounds the text with characters of the defined format to create both one or more prompts in the first defined format plus metadata in the second defined format and provides the prompts and metadata to the computerized system of knowledge or skills which responds with output based on the knowledge or skills.

9. The method of claim 8 wherein the computerized system of knowledge or skills is implemented on a computerized server that is accessed by the user across a computer network.

10. The method of claim 9 where the functions of the server computer and the functions of the user computer coexist on a single device or device array.

11. The method of claim 9 wherein the application program is implemented on a hand-held mobile computer device that accepts voice input and provides voice output and communicates with the computerized system of knowledge or skills across the computer network.

12. The method of claim 9 wherein the application program receives a text response from the computerized system of knowledge or skills, converts the text response to a voice response, and plays the voice response as output to the user.

13. A program product comprising
a non-transitory processor-readable medium on which program instructions configured to be executed by at least one processor are embodied along with associated data, wherein the associated data comprises
a bot name and, associated with the bot name, a scenario specification received from a user predominantly in free form natural human language which scenario specification constrains a range of possible responses output by a database of knowledge or skills, which database responds with output based on the knowledge or skills when prompt input is provided by a user, wherein, when executed by the at least one processor on a user computer, the program instructions cause the at least one processor to
receive from a user input of the bot name and, in response, send across a communications network to a database of knowledge or skills residing on a server the specification of a personally created natural human language bot scenario specified by the bot name as well as a prompt received from a user, and
the program instructions cause the at least one processor to receive a response from the database and display or play out the response, and
after the response is received, the program instructions cause the at least one processor to allow the server to delete the bot scenario specification from available memory.

14. The program product of claim 13 where the associated data comprising a bot name and associated with the bot name a specification of a bot scenario is stored on the user computer in a format of a portable computer file that can be copied to and used on another computer.

15. The program product of claim 13 where the at least one processor is within a mobile telephone.

16. The program product of claim 13 where the specification in natural human language text is provided by a user speaking voice input into a microphone coupled to the at least one processor which voice input is converted to text.

17. The program product of claim 13 where the database of knowledge or skills is a large language model artificial intelligence system.

18. The program product of claim 13 where the bot scenario specification input by the user consisting predominantly of natural human language instructions for guiding or constraining a bot in its desired behavior is retained by the user computer in a memory in human natural language text form and transmitted to the server in human natural language text form.

19. The program product of claim 13 where the bot scenario specification input by the user consisting predominantly of natural human language is converted by the user computer to a form other than human natural language text, is stored on the user computer in the converted form, and is sent to the server in the converted form.

20. The program product of claim 13 where allowing the server to delete the bot scenario specification from available memory is accomplished by the user computer sending nothing more to the server in association with the bot name within a time period.

21. The method of claim 1 where, after the server responds to the prompt, the bot scenario specification is allowed to be deleted from available memory on the server.

22. The method of claim 21 where allowing the server to delete the bot scenario specification from available memory is accomplished by the user computer sending nothing more to the server in association with the bot name within a time period.

23. The method of claim 1 where the bot scenario specification input by the user consisting predominantly of natural human language instructions for guiding or constraining a bot in its desired behavior is retained by the user computer in a memory in human natural language text form and transmitted to the server in human natural language text form.

24. The method of claim 1 where the bot scenario specification input by the user consisting predominantly of natural human language is converted by the user computer to a form other than human natural language text, is stored on the user computer in the converted form, and is sent to the server in the converted form.
